(19) United States
(12) Patent Application Publication
(10) Pub. No.: US 2004/0165484 A1
(43) Pub. Date: Aug. 26, 2004

(54) Method for preventing contact between a pickup head and an optical disc

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/769,956

(22) Filed: Feb. 2, 2004

(30) Foreign Application Priority Data
Feb. 26, 2003 (TW) 92104006

(51) Int. Cl. G11B 7/085

(52) U.S. Cl. 369/30.16; 369/30.24

(57) ABSTRACT

A method for preventing contact between a pickup head and an optical disc. First, a voltage is provided to the pickup head, thereby repositioning the pickup head closer to the optical disc from an initial position to a biased position. A track-seeking motion is executed to move the pickup head to a predetermined information track. The pickup head starts a vibration in the direction away from the disc when a focus error occurs during the track-seeking motion.

### BACKGROUND OF THE INVENTION

1. Field of the Invention

The present invention relates to a method for an optical pickup head operation, and in particular to repositioning the pickup head for preventing contact between a pickup head and an optical disc when focusing error occurs.

2. Description of the Related Art

With the development of optical storage media, data can be recorded and backed up in high capacity, lighter discs. Moreover, optical disc devices such as CD-ROM drives are becoming essential equipment in computer systems and electronic multimedia devices.

Recently, information is often stored on an optical disc in the form of a spiral physical track and can be divided into a plurality of information tracks. Furthermore, the information is stored on the optical disc in the form of regions with different optical properties on the information tracks such as with different reflectance, etc. When an optical disc drive is retrieving information from or recording information to an optical disc, the optical disc drive rotates the optical disc and retrieves information from or record information to the optical disc by emitting a light beam and receiving its reflecting beam via a pickup head. As the information tracks are in the form of a spiral physical track, the pickup head must be able to traverse along the radial direction to allow the pickup head continues aiming at the center of the physical track correctly while the optical disc rotates for retrieving or recording operations. And this motion of the pickup head and its direction are referred to as a track-following motion and a tracking direction, respectively. Moreover, in an optical storage device, the system that controls the motion mentioned here is referred to as a tracking servo system.

Before the track-following motion, a track-seeking motion is executed to move the pickup head to a predetermined information track. FIG. 1 is a cross-section of the pickup head and spindle of an optical disc storage device. An optical disc 11 has a spiral track 111 and is placed on a spindle 12 which rotates the optical disc 11. A pickup head 13 has a lens 131 and a fine actuator 132 which drives the track-following motion of the lens 131. Besides, a coarse actuator 14 drives a track-seeking motion of the pickup head 13. The track-seeking and the track-following motions accomplished together with the coarse actuator 13 and the fine actuator 132.

Generally, the pickup head traverses many information tracks radially during the track-seeking motion, wherein the number of information tracks traversed is calculated according to a tracking error signal. And a focus status is detected by a RF (radio frequency) signal output from the pickup head. For example, there is a signal pin “Focus OK” indicating whether the focus is correct or not on a chip of the optical disc drive. During the track-seeking motion, the pickup head continuously outputs the RF signal, and then the signal pin “Focus OK” of the chip maintains a normal state. On the contrary, the pickup head is unable to output RF signal correctly if external forces acting on it during the track-seeking motion and the “Focus OK” pin posts an abnormal state. Meanwhile, the pickup head is already out of control and vibrates irregularly and abnormally. The track-seeking motion will not resume until the vibration decays or stops. Conventionally, the vibration of the pickup head is unpredictable. When the initial direction of the vibration moves toward the optical disc, the optical disc may be damaged by the contact with the pickup head, and as can the lens itself.

Hence, it is necessary developing a method for preventing contact between a pickup head and an optical disc.

### SUMMARY OF THE INVENTION

Accordingly, an object of the invention is to provide a method for preventing contact between a pickup head and an optical disc. Before starting a track-seeking motion, a voltage is provided to the pickup head, thereby repositioning the pickup head from a initial position to a biased position. Then the track-seeking motion is executed to move the pickup head to a predetermined track. Thus the pickup head starts a vibration in the direction away from the disc when a focus error occurs during the track-seeking motion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-section showing the pickup head and the spindle of an optical disc storage device;

FIG. 2 is a cross-section showing the pickup head and the spindle of an embodiment according to the present invention;

FIG. 3 is a flowchart of the present invention.

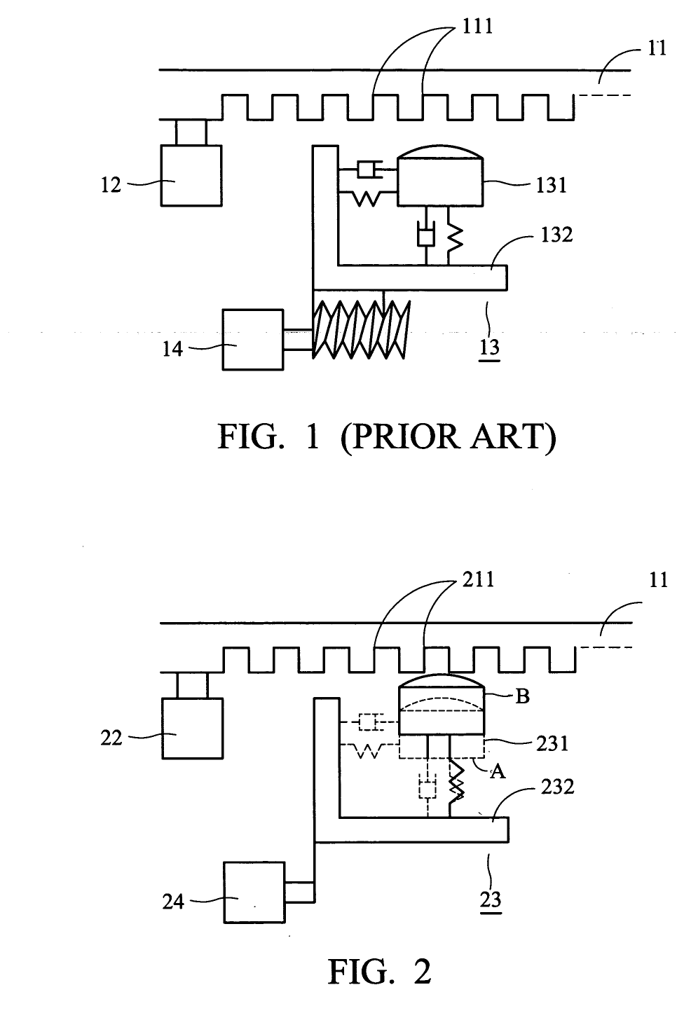

### DETAILED DESCRIPTION OF THE INVENTION

FIG. 2 is a cross-section showing the pickup head and the spindle of an embodiment according to the present invention. An optical disc 21 has a spiral physical track 211 and is placed on a spindle 22 which rotates the optical disc 21. A pickup head 23 has a lens 231 and a fine actuator 232 which drives a track-following motion of the lens 231. Besides, a coarse actuator 24 drives the track-seeking motion of the pickup head 23, and the track-seeking and the track-following motions accomplished together with the fine actuator 132.

When the track-seeking motion begins, the pickup head 23 is repositioned toward the optical disc 21 by a digital signal processing (DSP) such that the pickup head 23 is repositioned from an initial position A to a biased position B.

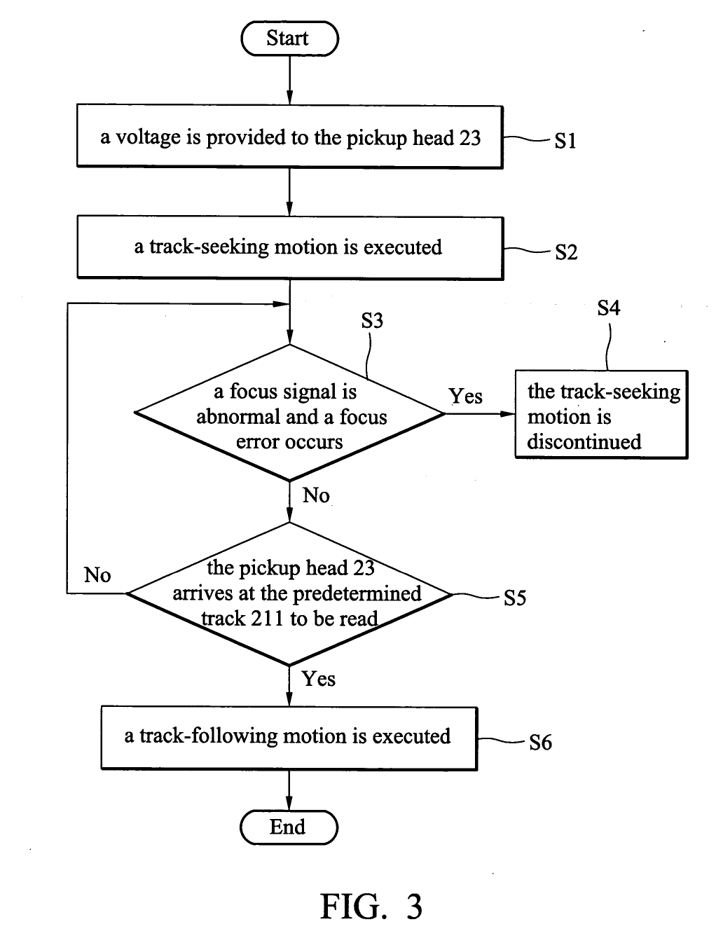

FIG. 3 is a flowchart of the present invention, in which, to read data from a predetermined information track 211 on an optical disc, a voltage is provided to the pickup head 23 (step S1) such that the pickup head 23 is repositioned closer to the optical disc from a initial position A to a biased position B. A track-seeking motion is executed (step S2) to move the pickup head 23 to the predetermined track 211. When a focus signal is abnormal and a focus error occurs (step S3) during the track-seeking motion, the pickup head 23 starts a vibration in the direction away from the disc and the track-seeking motion is discontinued (step S4). When the focus signal is normal and the pickup head 23 arrives at the predetermined information track 211 to be read (step S5), a track-following motion is executed (step S6). Otherwise, keep on monitoring the focus signal (step S3).

According to the method described above, before starting the track-seeking motion, a voltage is provided to the pickup head such that the pickup head is repositioned a predetermined distance toward the optical disc. When a focus error occurs during the track-seeking motion, the track-seeking motion is discontinued. Meanwhile, the pickup head vibrates. Because of the relocation of the pickup head and the resilience, the initial direction of the vibration of the pickup head is away from the optical disc. Thus, the method in the present invention can prevent the pickup head from contacting the optical disc, thus effectively preventing lens being damaged.

After discontinuation of the tack-seeking motion, the track-seeking motion can be resumed when the vibration of the pickup head decays or stops. Moreover, when the pickup head arrives at the predetermined information track and the focus signal is normal, the track-following motion is executed for accessing data.

In the present invention, the focus signal is generated according to a RF signal. As a result, the pre-displacement of the pickup head should be limited to ensure that the RF signal can be received and detected.

The method for preventing contact between a pickup head and an optical disc provides a relocation of the pickup head such that the pickup head is moved toward the optical disc in advance to ensure that the initial direction of vibration is away from the disc. Such that the present invention prevents contact and thereby damage of lens and discs when the pickup head out of control.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for preventing contact between a pickup head and an optical disc, comprising:
providing a voltage to the pickup head, thereby repositioning the pickup head closer to the optical disc from an initial position to a biased position; and
executing a track-seeking motion to move the pickup head to a predetermined information track;
wherein the pickup head starting a vibration from the biased position toward the direction away from the 11 disc when a focus error occurs during the track-seeking motion.

2. The method as claimed in claim 1, wherein a digital signal processor is used to provide the voltage.

3. The method as claimed in claim 1, wherein the focus error is defined according to a focus signal.

4. A method for preventing contact between a pickup head and an optical disc, comprising:
providing a voltage to the pickup head such that the pickup head is repositioned a predetermined distance closer to the optical disc;
executing a track-seeking motion to move the pickup head to a predetermined track; and
discontinuing the track-seeking motion when a focus error occurs.

5. The method as claimed in claim 4, wherein a digital signal processor is used to provide the voltage.

6. The method as claimed in claim 4, wherein the focus error is decided according to a focus signal.

7. The method as claimed in claim 4 further comprising executing a track-following motion when the pickup head arrives at the predetermined track.
